(19) United States
(12) Patent Application Publication
(10) Pub. No.: US 2008/0232890 A1
(43) Pub. Date: Sep. 25, 2008

(54) Movable print head for a label printer

(76) Inventors: Chin-Chuan Liu, Taipei City (TW); Hung-Kun Liao, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,418

(22) Filed: Mar. 20, 2007

(51) Int. Cl. B41J 33/02

(52) U.S. Cl. 400/229

(57) ABSTRACT

A movable print head is provided for a label printer, including: a control panel module having two pivots arranged on opposite sides of the control panel module and coupled to opposite sides of a body of the label printer to serve as rotational center for rotation of the control panel module; and a printing module fixed to an internal vertical surface of the control panel module and including two guide-in devices on opposite sides of the printing module to guide in an ink ribbon cartridge and a print head arranged between the two guide-in devices. The two guide-in devices of the printing module are movable in unison with the rotation of the control panel module to effect movable adjustment for guiding in the ink ribbon cartridge.

### BACKGROUND OF THE INVENTION

1. Field of the Invention

The present invention generally relates to a label printer, and in particular to a movable print head of the label printer.

2. The Related Arts

In a conventional label printer, an ink ribbon cartridge is fixed inside the label printer. Thus, each time the ink ribbon cartridge is to be replaced, the operation of replacing the ink ribbon cartridge is constrained by the internal structure of the label printer. The trend of miniaturization of the label printer makes of the mechanics inside the printer more complicated than ever. Thus, it becomes troublesome of general uses to replace and mount ink ribbon cartridge into the label printer. Although detachable ink ribbon cartridge is available and effectively solves the problem, the detachable ink ribbon cartridge suffers difficulty in precisely aligning the ink ribbon cartridge with corresponding rails or guide-in devices, which are often formed inside the compact-sized label printer, before the ink ribbon cartridge is properly coupled to the label printer. Apparently, the detachable ink ribbon cartridge still has to be designed and mounted under the constraints imposed by the compact structure of the label printer. In other words, the detachable ink ribbon cartridge does not completely solve the above-discussed problem.

### SUMMARY OF THE INVENTION

Thus, the present invention is aimed to provide a movable print head for a label printer, which comprises rails or guide-in mechanisms corresponding to counterpart devices formed in an ink ribbon cartridge and which, in installing an ink ribbon cartridge, effects movable adjustment for conveniently coupling the ink ribbon cartridge to the label printer so as to completely solve problem discussed above.

To realize the above object, in accordance with the present invention, a movable print head is provided for a label printer. The movable print head includes: a control panel module having two pivots arranged on opposite sides of the control panel module and coupled to opposite sides of a body of the label printer to serve as rotational center for rotation of the control panel module; and a printing module fixed to an internal vertical surface of the control panel module and including two guide-in devices on opposite sides of the printing module to guide in an ink ribbon cartridge and a print head arranged between the two guide-in devices. The two guide-in devices of the printing module are movable in unison with the rotation of the control panel module to effect movable adjustment for guiding in the ink ribbon cartridge.

### BRIEF DESCRIPTION OF THE DRAWINGS

In order to clearly show and make better comprehension of these and other features and advantages of the present invention, the present invention will now be described by way of examples, with reference to a preferred embodiment illustrated in the drawings, in which:

FIG. 1 shows a schematic side elevational view of a label printer in which a movable print head in accordance with a preferred embodiment of the present invention is embodied and an ink ribbon cartridge;

FIG. 2 shows an exploded view of the label printer that embodies the movable print head in accordance with the present invention and the ink ribbon cartridge;

FIG. 3 is an exploded view of the preferred embodiment of the present invention illustrating the condition before the ink ribbon cartridge is mounted to the label printer, and

FIG. 4 is also is an exploded view of the preferred embodiment of the present invention illustrating the condition after the ink ribbon cartridge is mounted to the label printer.

### DETAILED DESCRIPTION OF THE PREFERRED EMBODIMENT

An embodiment of a movable print head of a label printer constructed in accordance with the present invention will be described hereinafter. However, it is apparent that the present invention is not limited to the specific embodiment described in the following and is equally applicable to other embodiments. Although a detailed description of the preferred embodiment of the present invention will be given as follows, the present invention can also be extensively employed in other applications whereby the scope of the present invention is defined solely by the claims that are given after the detailed description of the preferred embodiment of the present invention. Further, to more clearly illustrate the principles of the present invention, constituent parts constructing the present invention are not illustrated to exact scale thereof and some are exaggerated and some are omitted for simplicity.

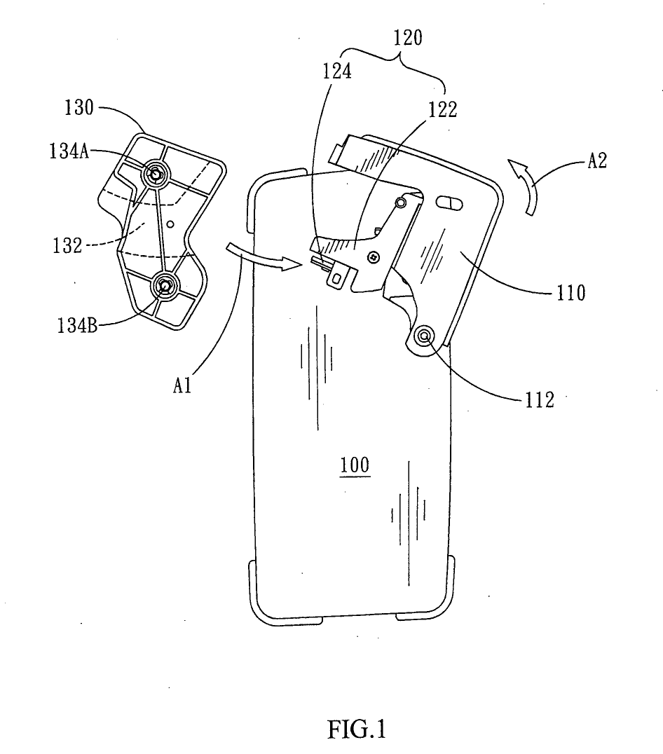

With reference to the drawings and in particular to FIG. 1, which shows a schematic side elevational view of a label printer in which a movable print head in accordance with a preferred embodiment of the present invention is embodied and an ink ribbon cartridge, a control panel module 110 has two pivots 112 respectively formed on opposite sides of the control panel module 110, of which one pivot is not visible in the drawings. In the embodiment illustrated, the control panel module 110 comprises an inverted L-shaped frame and the pivots 112 are formed on lower portions of two sides of the inverted L-shaped frame, as shown in the drawings. The two pivots 112 can be coupled to opposite sides of a label printer body 100 by two snap-on fasteners, or alternatively, the two pivots 112 are coupled to the opposite sides of the label printer body 100 by two bolts so as to connect the pivots 112 to the opposite sides of the label printer body 100 in such a way to allow the control panel module 110 to rotate about a rotation center defined by the pivots 112 in a rotational direction designated by arrow A2 or in a direction opposite thereto. It is noted that the term “label printer body” as used herein intends to cover all other mechanisms and parts of a label printer other than the control panel module 110 and a printing module 120 (which will be further described later) and those mechanisms and parts do not constitute novel portions of the present invention and are known to those having ordinary skills in the art so that no further detail will be given with respect to those mechanisms and parts.

The printing module 120 comprises two guide-in devices 122 (one of the guide-in devices being invisible in the drawings) and a print head 124. The printing module 120 is fixed to an internal vertical surface of the control panel module 110 with the two guide-in devices 122 located on opposite sides of the printing module 120 for guiding in an ink ribbon cartridge 130 and the print head 124 located between the connected to the two guide-in devices 122. In the embodiment illustrated, the two guide-in devices 122 comprise two L-shaped side plates, which serve to guide two corresponding rails 132 (shown in phantom lines) of the ink ribbon cartridge 130, which rails are opposite to each other, for coupling the ink ribbon cartridge 130 to the printing module 120. However, in an alternative embodiment, the guide-in devices 122 may comprise two rails formed on cavities defined in opposite sides of the printing module 120 for guiding two opposite raised guides formed on the ink ribbon cartridge 130 to couple the ink ribbon cartridge 130 to the printing module 120.

It is emphasized here that, in accordance with the present invention, the guide-in devices 122 are rotatable in unison with the rotation of the control panel module 110 about the pivots 112 in the rotational direction A2 or the opposite direction. This provides a movable adjustment for installation of the ink ribbon cartridge 130 to the printing module 120. In other words, when the movable printing device comprised of the control panel module 110 and the printing module 120 is moved upward for opening (in the direction opposite to the arrow A2), the ink ribbon cartridge 130 can be slide into the movable printing device as being guided by the guide-in devices 122 in the direction designated by arrow A1 (insertion direction) and complicated operation of installation and positioning of the conventional ink ribbon cartridge can thus be eliminated. When the movable printing device is moved downward for closing in the direction designated by arrow A2, the ink ribbon cartridge 130 is moved in union therewith and thus properly positioned and installed. This not only simplifies the installation of the ink ribbon cartridge 130 into the label printer, but also enhances positioning precision and reliability of the installation of the ink ribbon cartridge. Further, the ink ribbon that is extended between a first shaft 134A and a second shaft 134B of the ink ribbon cartridge 130 can be correctly positioned below the print head 124 after the ink ribbon cartridge 130 and the movable printing device are properly positioned and no further adjustment of the ink ribbon cartridge 130 is needed.

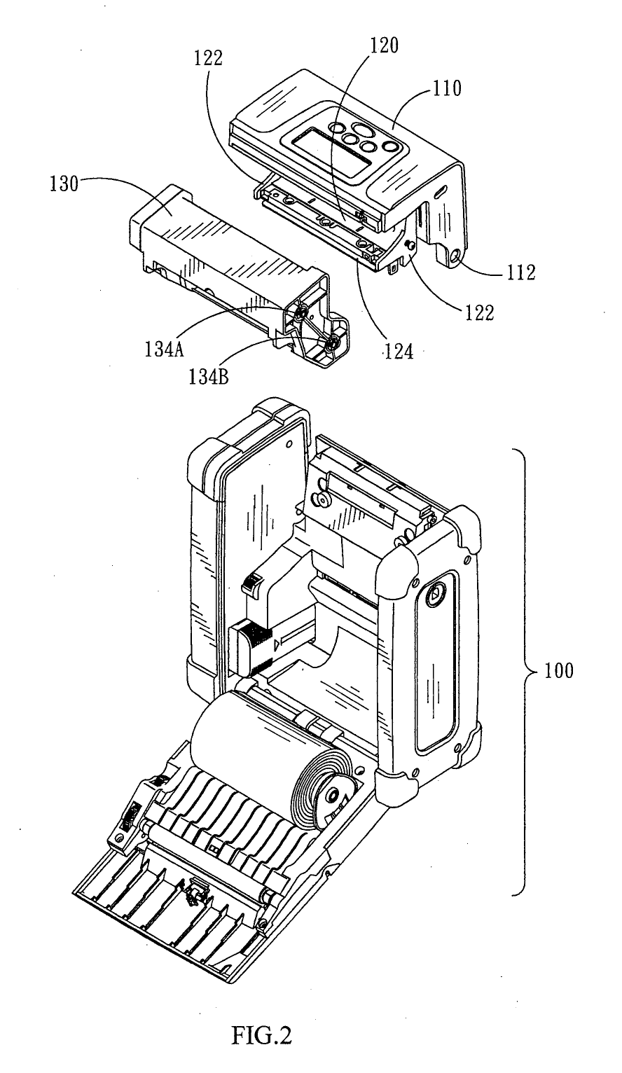

Also referring to FIG. 2, which shows an exploded view of the label printer that embodies the movable print head in accordance with the present invention and the ink ribbon cartridge, the modules and elements shown in FIG. 2 are the same as those shown in FIG. 1 and are designated with the same reference numerals. The function, operation, spatial relationship between the modules and elements of FIG. 2 are identical to those of FIG. 1 and thus repeated description is not necessary herein.

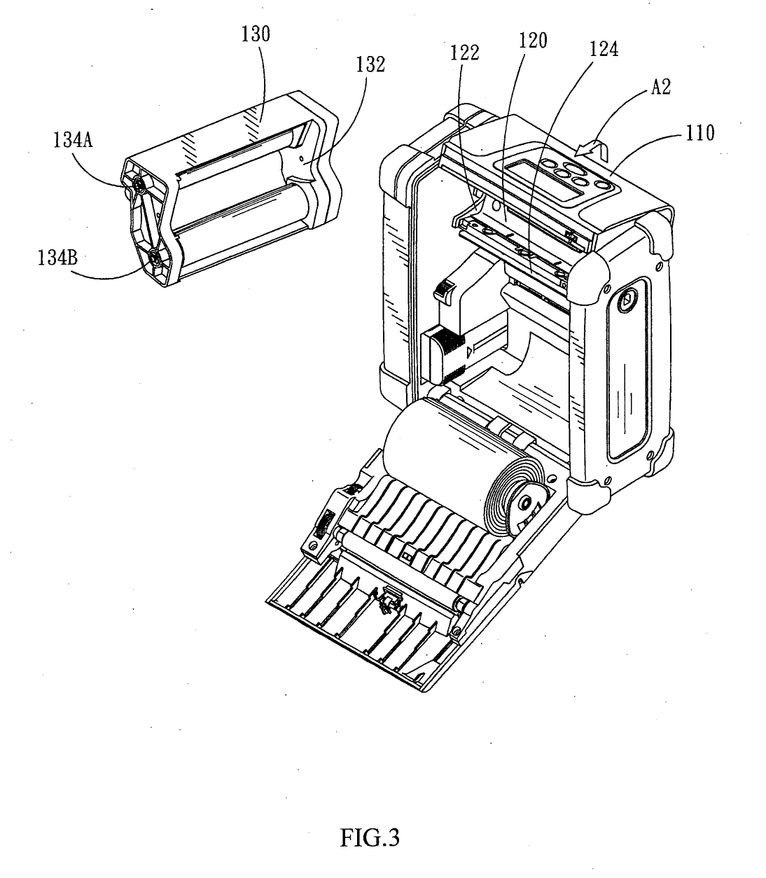

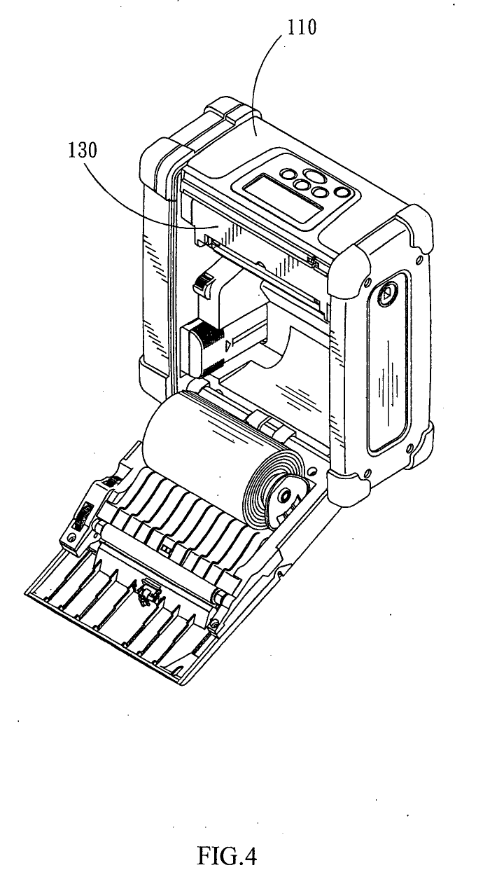

Also referring to FIGS. 3 and 4, which are exploded views of the preferred embodiment of the present invention illustrating the conditions before and after the ink ribbon cartridge is mounted to the label printer, rails 132 of the ink ribbon cartridge 130 shown in FIG. 3 corresponds to the rails shown with phantom lines of FIG. 1. Thus, the drawing of FIG. 3 provides a better and clearer illustration of the rails 132. Other modules and elements identical to those shown in FIG. 1 bear the same reference numerals and further and repeated description will not be given again.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A movable print head for a label printer, comprising:
a control panel module comprising two pivots on opposite sides of the control panel module, the pivots being coupled to opposite sides of a body of the label printer to serve as rotational center for rotation of the control panel module; and
a printing module fixed to an internal vertical surface of the control panel module, the printing module comprising two guide-in devices on opposite sides of the printing module to guide in an ink ribbon cartridge and a print head arranged between the two guide-in devices;
wherein the two guide-in devices of the printing module are movable in unison with the rotation of the control panel module to effect movable adjustment for guiding in the ink ribbon cartridge.

2. The movable print head as claimed in claim 1, wherein the control panel module comprises an inverted L-shaped frame.

3. The movable print head as claimed in claim 1, wherein the two pivots of the control panel module are coupled to the opposite sides of the label printer body by two snap-on fasteners.

4. The movable print head as claimed in claim 1, wherein the two pivots of the control panel module are coupled to the opposite sides of the label printer body by two bolts.

5. The movable print head as claimed in claim 1, wherein the two guide-in devices comprise two L-shaped side plates serving to guide two opposite rails formed on the ink ribbon cartridge for coupling the ink ribbon cartridge to the printing module.

6. The movable print head as claimed in claim 1, wherein the two guide-in devices comprise two rails for guiding opposite raised guides of the ink ribbon cartridge to couple the ink ribbon cartridge to the printing module.
